(19) United States
(12) Patent Application Publication
(10) Pub. No.: US 2004/0207750 A1
(43) Pub. Date: Oct. 21, 2004

(54) Image pick-up device for mounting on high power monocular (telescope or spotting scope)

(76) Inventors: Kuocheng Wu, Hsinchu (TW); Will Jiang, Hsinchu (TW)

Correspondence Address: RABIN & BERDO, P.C., 1101 14th Street, N.W., Suite 500, Washington, DC, 20005, US

(21) Appl. No.: 10/413,490

(22) Filed: Apr. 15, 2003

(51) Int. Cl. H04N 5/225; G02B 23/00

(52) U.S. Cl. 348/375; 348/360; 359/399

(57) ABSTRACT

A digital image pick-up device for mounting on a high power monocular (telescope or spotting scope) includes an image pick-up unit located in a focal plane of the objective lens of the high power monocular (telescope or spotting scope); an angle-adjusting unit for adjusting an angle of the whole image pick-up device relative to the high power monocular (telescope or spotting scope); an image storage unit for storing images read in by the image pick-up unit; and a display unit for showing images read in by the image pick-up unit. When the digital image pick-up device is connected to a rear end of the high power monocular (telescope or spotting scope) with an eyepiece of the latter removed therefrom, an economical and convenient high power monocular (telescope or spotting scope) and camera combination is formed to enable picking up, processing, storing, and displaying of images in a digitalized manner.

### FIELD OF THE INVENTION

The present invention relates to a digital image pick-up device that can be mounted on a high power monocular (spotting scope or telescope) to enable a user to pick up an image of a dynamic or a static object or scene being viewed with the high power monocular (telescope or spotting scope) and store the picked up image in a memory device.

### BACKGROUND OF THE INVENTION

People usually use a telescope to watch birds or observe various heaven objects, and often want to keep any favorite scene as a memorial. To do so, the user has to additionally prepare complicate and valuable photographic equipment and own professional photographic skill. When a conventional still camera is used to take pictures of favorite objects or scenes, it is also necessary to develop films and print the pictures. To enable keeping of beautiful images through easy operation, it is desirable to improve the existing photographic technologies for users to enjoy photography in a more convenient and economical manner.

FIG. 1 shows a conventional high power monocular (telescope or spotting scope) 60 having an eyepiece 61 connected to a rear end thereof, such that images of external objects or scenes at a long distance away may be clearly observed or viewed at the eyepiece 61.

There has been developed a binocular and digital camera combination to integrate functions of the binocular and the digital camera. In the binocular and digital camera combination, the optical path of the camera and that of the binocular are independent of one another. Such a combination is normally designed for use with a low-power compact binocular, and therefore has an objective lens having relatively short focal length and limited light collecting capability, making it not suitable or practical for use with a high-power telescope designed for long-distance bird watching or astronomical observation to obtain good image quality.

It has been quite a long time since a complementary metal-oxide semiconductor (CMOS) (or a charged-couple device, CCD) camera was mounted onto an astronomical telescope to take pictures. However, since the CMOS (or CCD) camera having high sensitivity is relatively expensive and must be equipped with a cooling means and operated indoors, it is more suitable for use in an astronomical observatory or other similar professional organizations. It is therefore desirable to develop an image pick-up device that is convenient and practical for use with an amateur telescope for astronomical observers and natural scene lovers to carry and use it easily.

A conventional high power monocular (telescope or spotting scope) and digital camera combination is formed simply by connecting the digital camera to the eyepiece of the high power monocular (telescope or spotting scope) and has the following disadvantages:

1. The picture taken with the digital camera connected to the rear end of the eyepiece of the high power monocular (telescope or spotting scope) usually has a so-called black eye. That is, due to a problem of mismatch of the pupil of the high power monocular (telescope or spotting scope) and the digital camera, the picture would have a black peripheral area surrounding a central portion of the picture showing the image.

2. Since the image formation on the camera is achieved through the eyepiece of the high power monocular (telescope or spotting scope), the contrast of the image taken with the camera become worse to lower the image quality.

3. It is difficult and time-consuming to mount the camera onto the conventional high power monocular (telescope or spotting scope). When the digital camera is connected to the high power monocular (telescope or spotting scope), its lens must be well aligned with the eyepiece end of the high power monocular (telescope or spotting scope), and an optical axis of the digital camera must be coaxial and aligned with an optic axis of the high power monocular (telescope or spotting scope) to enable photographing with the camera.

4. It is very often the high power monocular (telescope or spotting scope) is upward or downward inclined for observation purpose. In these inclined positions, a user is not able to successfully and clearly view the image shown on a liquid crystal display (LCD) of the camera. It is very possible for the user to incorrectly set the focus due to an error in the viewing angle and therefore take a poor picture.

### SUMMARY OF THE INVENTION

It is a primary object of the present invention to provide an image pick-up device for mounting on a high power monocular (telescope or spotting scope) to eliminate drawbacks existed in the conventional high power monocular (telescope or spotting scope) and digital camera combination.

To achieve the above and other objects, the image pick-up device of the present invention is specially designed for use with a high-power monocular (telescope or spotting scope) available in the market for bird watching or astronomical observation to take pictures of the watched birds or observed heaven objects. The image pick-up device of the present invention is mounted on the high power monocular (telescope or spotting scope) to replace an eyepiece of the high power monocular (telescope or spotting scope), and includes an adapter, which is a standard interface, to enable easy connection of the device via the adapter to any commercially available high power monocular (telescope or spotting scope) having a removable eyepiece for taking a perfect digital picture of distant objects or scenes, and an angle-adjusting unit to enable easy and smooth adjustment of an LCD of the device to an angle best and most comfortable for viewing.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a perspective view of a conventional high power monocular (telescope or spotting scope);

FIG. 2 is a perspective view showing the mounting of an image pick-up device of the present invention onto a conventional high power monocular (telescope or spotting scope) of FIG. 1;

FIG. 3 is a partially exploded perspective view of FIG. 2;

FIG. 4 is a flowchart explaining operations of the present invention;

FIG. 5 shows the range of angle within which the present invention may be adjusted relative to the high power monocular (telescope or spotting scope) onto which the present invention is mounted;

FIG. 6 shows an example of application of the present invention; and

FIG. 7 is a left plan side view of FIG. 2.

### DETAILED DESCRIPTION OF THE PREFERRED EMBODIMENTS

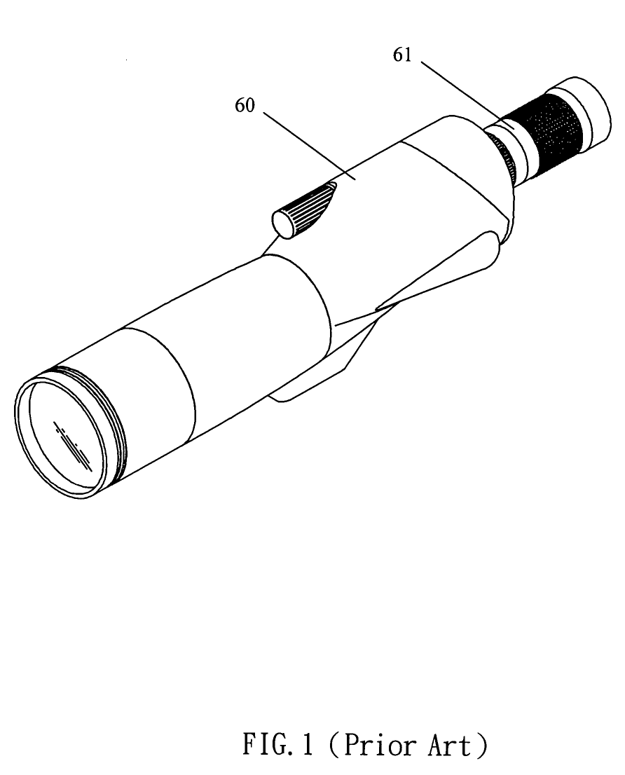

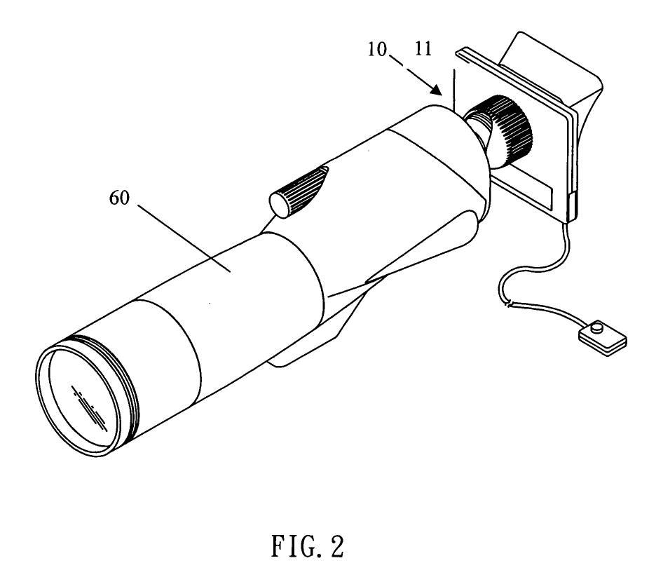

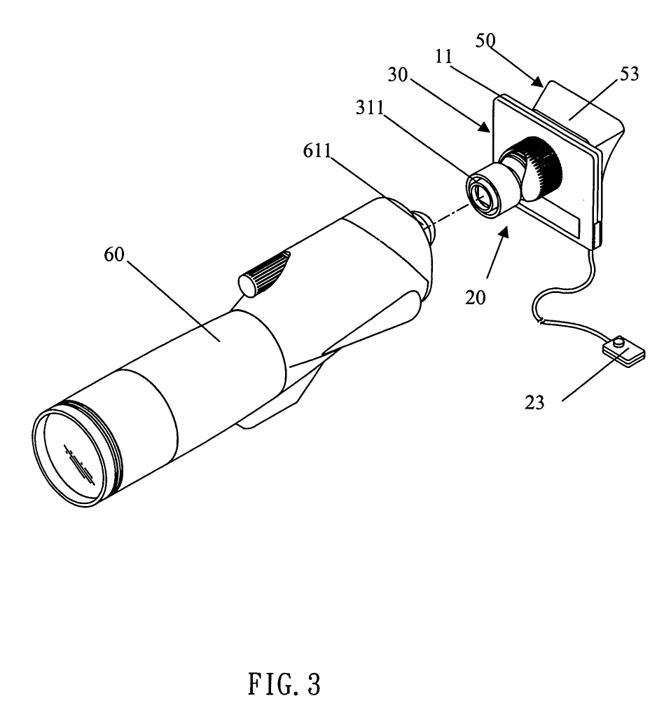

Please refer to FIGS. 2 and 3 that are assembled and exploded perspective views, respectively, of a high power monocular (telescope or spotting scope) and digital camera combination formed by connecting a digital image pick-up device 10 of the present invention to a conventional high power monocular (telescope or spotting scope) 60. By comparing with the conventional high power monocular (telescope or spotting scope) 60 shown in FIG. 1, it can be clearly seen that the device 10 is connected to a rear end of the high power monocular (telescope or spotting scope) 60 to replace an eyepiece 61 of thereof. As a common international practice, the eyepiece 61 is connected to the rear end of the conventional high power monocular (telescope or spotting scope) 60 via an eyepiece adapter ring 611 (see FIG. 3) that is a standard interface. On the other hand, the device 10 of the present invention is provided at a front end of an angle-adjusting unit 30 thereof with an adapter shaft 311, which is also a standard interface the same as the eyepiece adapter ring 611. Therefore, the device 10 may be directly connected to the eyepiece adapter ring 611 of the conventional high power monocular (telescope or spotting scope) 60 after the eyepiece 61 is removed therefrom. No other adapting device is needed to mount the device 10 of the present invention onto the high power monocular (telescope or spotting scope) 60.

The digital image pick-up device 10 externally includes a case 11, an angle-adjusting unit 30 provided at a front side of the case 11, and a display unit 50 provided at a rear side of the case 11. The device 10 also internally includes an image pick-up unit 20 that could be controlled via an external wire-controlled shutter release 23 to enable a user to take a picture without shaking the device 10 to result in poor image quality of the picture, and an image storage unit 40.

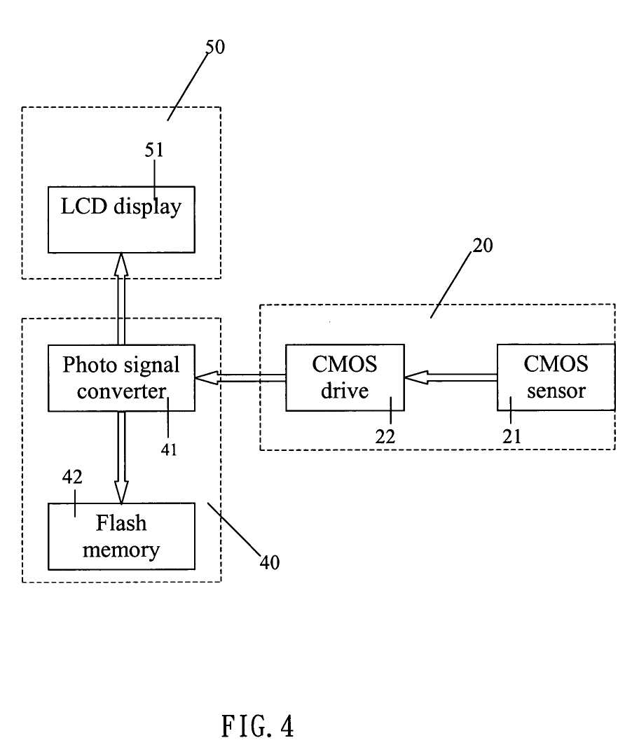

Please refer to FIG. 4 that is a flowchart explaining operations of the present invention. A digital sensor 21 included in the image pick-up unit 20 reads in a desired image, and the read-in image is converted into a digital signal by a digital (CMOS or CCD) image drive 22 of the image pick-up unit 20. The converted digital signal is sent to a photo signal converter 41 of the image storage unit 40, and then output to an LCD 51 of the display unit 50, or stored in a flash memory of the image storage unit 40 via control of the wire-controlled shutter release 23.

According to an internal structure of the high power monocular (telescope or spotting scope) 60, an image of a distant object or scene is focused on a focal plane of the objective lens of the high power monocular (telescope or spotting scope) at where the eyepiece 61 is located. In the present invention, a read-in position for the digital sensor 21 is set to the above-mentioned focal plane. Therefore, when the device 10 is mounted onto the high power monocular (telescope or spotting scope) 60 to replace the eyepiece 61, the image of the distant object or scene is directly read in by the digital sensor 21 and then subjected to processing by the digital image drive 22 and the photo signal converter 41.

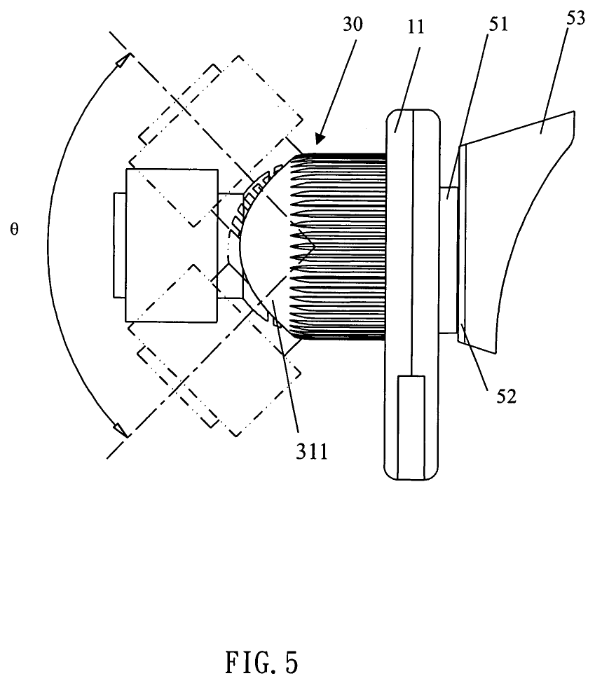

Please refer to FIG. 5. The angle-adjusting unit 30 of the digital image pick-up device 10 enables adjustments of an angle θ at which the device 10 is positioned relative to the high power monocular (telescope or spotting scope) 60. As can be seen from FIG. 5, the angle θ is within a range from at least +45° to at least −45° relative to a center axis of the high power monocular (telescope or spotting scope) 60. With the angle-adjusting unit 30, a user may view distant objects and scenes via the device 10 in a more comfortable manner. The case 11 is connected to the LCD 51 of the display unit 50 behind the case 11. To enable the user to observe from a dimension-increased viewing window, a Fresnel lens 52 characterized in a light, thin, and flat structure is mounted in front of the LCD 51. The Fresnel lens 52 also enables the user to perform the focal alignment more accurately for the high power monocular (telescope or spotting scope).

To avoid unnecessary light hazards, a hood 53 may be mounted around the Fresnel lens 52 to block any interference from unwanted strong light. The hood 53 also protects the LCD 51 against dust and other falling things.

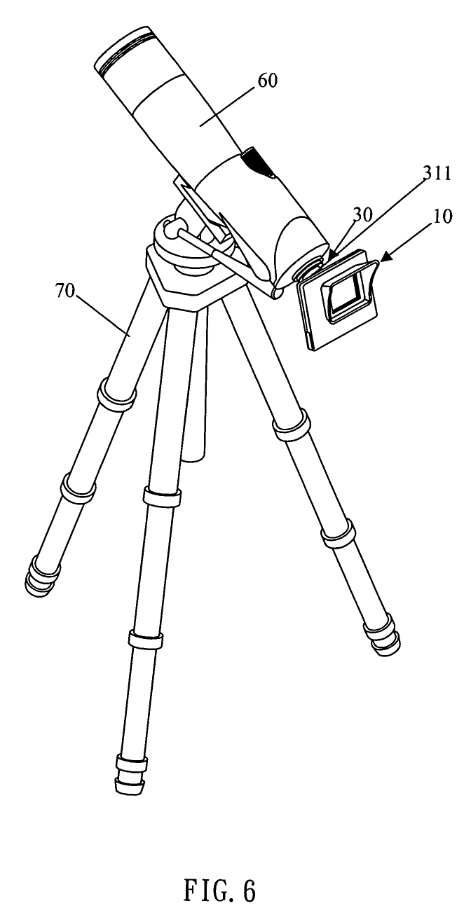

The high power monocular (telescope or spotting scope) 60 is normally heavier than a general low-power telescope. It is preferable a tripod 70 is used to support and hold the high power monocular (telescope or spotting scope) 60 in place, as shown in FIG. 6. When the tripod 70 is set to a relatively large angle of elevation for, for example, an astronomical observation, the device 10 may be relatively adjusted via the angle-adjusting unit 30 to a suitable angular position for the user to observe the heaven objects comfortably.

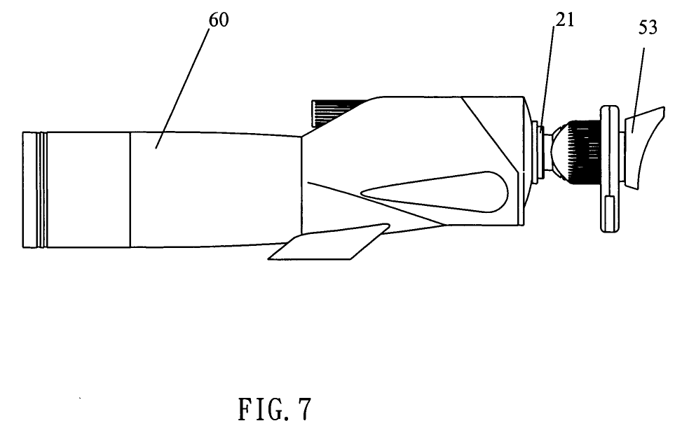

Please refer to FIG. 7. The image pick-up device 10 of the present invention does not pick up an image from the eyepiece 61 but reads in the image fallen on the focal plane of objective lens at where the image read-in position for the digital sensor 21 is set. Therefore, a picture taken with the device 10 mounted on the high power monocular (telescope or spotting scope) 60 does not reduce the contrast of the image but eliminates black peripheral area to show a good image on the picture.

With a high power monocular (telescope or spotting scope) and camera combination formed by mounting the digital image pick-up device 10 of the present invention onto a conventional high power monocular (telescope or spotting scope) 60 with the eyepiece 61 of the latter removed therefrom, factors, such as white fog and black peripheral area, that have adverse influences on the image quality of the picture as found in the conventional telescope and camera combination all can be eliminated. Moreover, with the adapter shaft 311 that is a standard interface, the device 10 may be easily mounted onto the eyepiece end of the high power monocular (telescope or spotting scope) 60 without the need of aligning the center axis of the digital camera with the optic center of the high power monocular (telescope or spotting scope) to take the picture.

The present invention has been described with a preferred embodiment thereof and it is understood that many changes and modifications in the described embodiment can be carried out without departing from the scope and the spirit of the invention as defined by the appended claims.

What is claimed is:

1. An image pick-up device for mounting on a high power monocular (telescope or spotting scope), comprising:
an image pick-up unit located in a focal plane of the objective lens of said high power monocular (telescope or spotting scope);
an angle-adjusting unit for adjusting an angular position of said image pick-up device relative to said high power monocular (telescope or spotting scope);
an image storage unit for storing images read in by said image pick-up unit; and
a display unit for showing images read in by said image pick-up unit.

2. The image pick-up device for mounting on a high power monocular (telescope or spotting scope) as claimed in claim 1, wherein said image pick-up unit includes a digital sensor, a digital image drive, and a wire-controlled shutter release.

3. The image pick-up device for mounting on a high power monocular (telescope or spotting scope) as claimed in claim 2, wherein said digital sensor has a receiving end located in said focal plane of the objective lens of said high power monocular (telescope or spotting scope).

4. The image pick-up device for mounting on a high power monocular (telescope or spotting scope) as claimed in claim 1, wherein said angle-adjusting unit includes an angle adjusting mechanism.

5. The image pick-up device for mounting on a high power monocular (telescope or spotting scope) as claimed in claim 4, wherein said angle adjusting mechanism enables turning of said image pick-up device relative to said high power monocular (telescope or spotting scope) by an angle within the range from +45° to −45° relative to a center axis of said high power monocular (telescope or spotting scope).

6. The image pick-up device for mounting on a high power monocular (telescope or spotting scope) as claimed in claim 1, wherein said image storage unit includes a photo signal converter and a flash memory.

7. The image pick-up device for mounting on a high power monocular (telescope or spotting scope) as claimed in claim 1, wherein said display unit includes an LCD display and a Fresnel lens.

8. The image pick-up device for mounting on a high power monocular (telescope or spotting scope) as claimed in claim 7, wherein said Fresnel lens has a light-blocking hood mounted there around.
